(19) United States
(12) Patent Application Publication
(10) Pub. No.: US 2002/0123969 A1
(43) Pub. Date: Sep. 5, 2002

(54) Computer-supported project planning tool, apparatus, and method of use thereof

(76) Inventors: Christiane Foertsch, Erlangen (DE); Toni Kress, Lauf (DE)

Correspondence Address: HARNESS, DICKEY & PIERCE, P.L.C., P.O.BOX 8910, RESTON, VA, 20195, US

(21) Appl. No.: 10/084,154

(22) Filed: Feb. 28, 2002

(30) Foreign Application Priority Data
Feb. 28, 2001 (DE) 10109541.4

(51) Int. Cl. G06F 17/60; H04K 1/00; H04L 9/00

(52) U.S. Cl. 705/63; 705/8

(57) ABSTRACT

A technical installation is planned using a computer-supported project planning tool, by interactively specifying a number of descriptions of technical elements and by describing their topology. For this purpose, a user either selects, from at least one catalogue of predefined, unchangeable standard description of elements, of which descriptions and a priority number is assigned, or specifies a different description of the project planning tool. The planned installation is assigned this priority number by the project planning tool only if such standard descriptions are specified.

This application hereby claims priority under 35 U.S.C. § 119 on German application number DE 10109541.4 filed Feb. 28, 2001, the entire contents of which are hereby incorporated herein by reference.

### FIELD OF THE INVENTION

The present invention generally relates to a computer-supported project planning tool, apparatus, and method of use thereof. Preferably, via such a tool, a technical installation can be planned by interactively specifying a number of descriptions of technical elements and by describing their topology.

Within the sense of the application, project planning preferably refers not only to the predefining of the respective description, but also at the same time at least partial checking and reconciliation of the input data for consistency and/or compatibility. In the case of a screw connection of a bolt to a nut, the bolt is, for example, always given such length dimensions that the nut can be screwed onto the bolt. In addition, the connection is dimensioned in accordance with predefinable loading criteria. Bolts and nuts must also necessarily have the same thread diameter and the same pitch. In the case of electrical engineering, care is taken to ensure that the selected elements have compatible voltages, and power supply units, switches, fuses and, for example, also cables are given sufficient dimensions. The project planning tool may also possibly make correction proposals or carry out automatic corrections. In addition, the project planning of the technical installation is represented—preferably also in a graphic way.

### BACKGROUND OF THE INVENTION

An important question when planning a technical installation is whether the installation has the properties stipulated in the project planning when it is actually constructed.

### SUMMARY OF THE INVENTION

An object of an embodiment of the present invention is to provide a computer-supported project planning tool, apparatus and method of use thereof. More preferably, it involves providing a tool, via which it is easy for the user to detect whether or not the installation has properties stipulated in the project planning when it is actually constructed.

Preferably, an object of an embodiment of the invention is achieved by making it possible for a user of the project planning tool to be offered, for selection, at least one catalog. Such a catalog can include a number of predefined standard descriptions of elements, wherein standard descriptions cannot be changed from the project planning tool by the user and to which a first description priority number is assigned. Further, it is preferably possible to specify at least one further description of the project planning tool. In addition, an installation priority number may be assigned to the planned technical installation by the project planning tool. Still further, the first description priority number may be assigned to the planned technical installation by the project planning tool as an installation priority number if only standard descriptions, to which the first description priority number is assigned, are selected for the project planning of the technical installation. Even further, an installation priority number which is different from the first description priority number may be otherwise assigned to the planned technical installation by the project planning tool.

In the case of a technical installation which is composed only of elements whose standard description is assigned the first description priority number, it is ensured that that standard description functions satisfactorily if the first description priority number is assigned only standard descriptions of elements which have been checked in terms of hardware for compliance with the technical criteria stipulated by the project planning tool.

A further important question when planning a technical installation is whether the installation can be at all constructed in the form in which it is planned. For this purpose, the further descriptions comprise at least one individual description which can be produced from the project planning tool by the user and at least one predefined standard description which cannot be changed from the project planning tool by the user and which is assigned a second description priority number which is different from the first description priority number,. Further, the second description priority number may be assigned to the planned technical installation by the project planning tool as an installation priority number, if only standard descriptions are selected for planning the technical installation and at least one of the selected standard descriptions is assigned the second description priority number. In addition, the installation priority number otherwise has a value which can be different from the description priority numbers.

If the catalog of the predefined standard descriptions contains only elements which describe commercially available products, the project planning tool assigns the technical installation a value which is different from the description priority numbers, and also only a description of an element, which the project planning tool does not know is available or not, is specified.

The predefined standard descriptions can be an integral component of the project planning tool. However, they can preferably be read by at least one file, referred to below as standard file. This file is preferably embodied as an ASCII file because it can then be produced via any customary editor.

If the predefined elements and their topology can be stored in an installation file, the project planning can easily be documented. The installation file is also preferably an ASCII file.

If, for the selection of a standard description, the user can be offered a subset of the number of predefined standard descriptions, this results in a particularly easy planning of the technical installation.

If the standard description can be called by the project planning tool from a computer network, the user of the project planning tool can always easily be provided with the most up-to-date version of the standard descriptions.

In principle, the project planning tool can be used universally. However, the elements are preferably electrical elements and the properties electrical, electronic or electromechanical properties. Examples of such elements are low-voltage switching devices and the elements which are connected upstream or downstream of them.

### BRIEF DESCRIPTION OF THE DRAWINGS

Further advantages and details emerge from the following description of an exemplary embodiment. Here, in basic views, the drawings include:

FIG. 1 shows an example of a technical installation,

FIG. 2 shows a computer,

FIG. 3 shows a flowchart,

FIG. 4 shows a detail from FIG. 3, and

FIG. 5 shows a variant of FIG. 4.

### DETAILED DESCRIPTION OF THE PREFERRED EMBODIMENTS

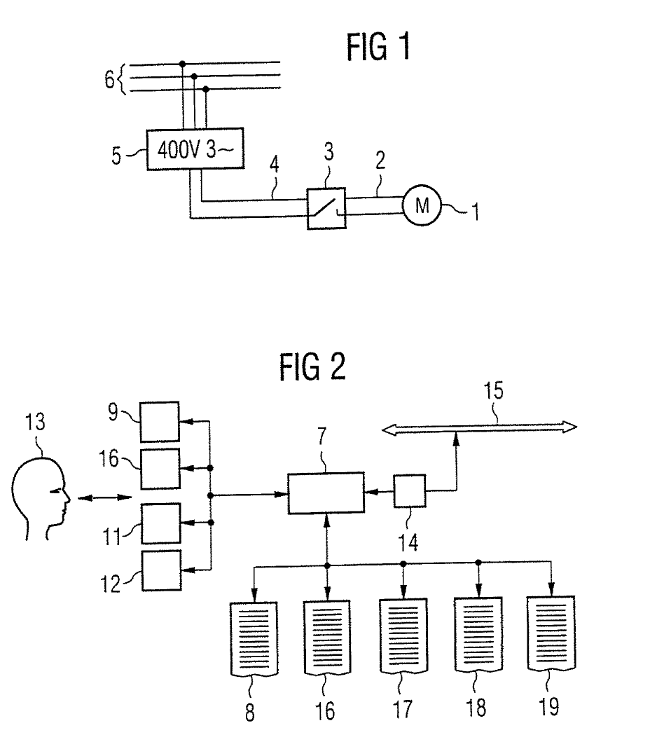

FIG. 1 shows a very simple example of a technical installation. According to FIG. 1, it has a motor 1 which is connected via a cable 2, a contactor 3 and a further cable 4 to a power supply module 5. The power supply module 5 is fed via a three-phase power system 6. The elements 1 to 5 of the technical installation are thus electrical elements, namely a low-voltage switching device (contactor 3), the elements (cable 4 and power supply module 5) connected upstream of it and the elements (cable 2 and motor 1) connected downstream of it. The topology of the technical installation is determined here by which of the elements 1 to 5 are connected to which of the other elements 1 to 5.

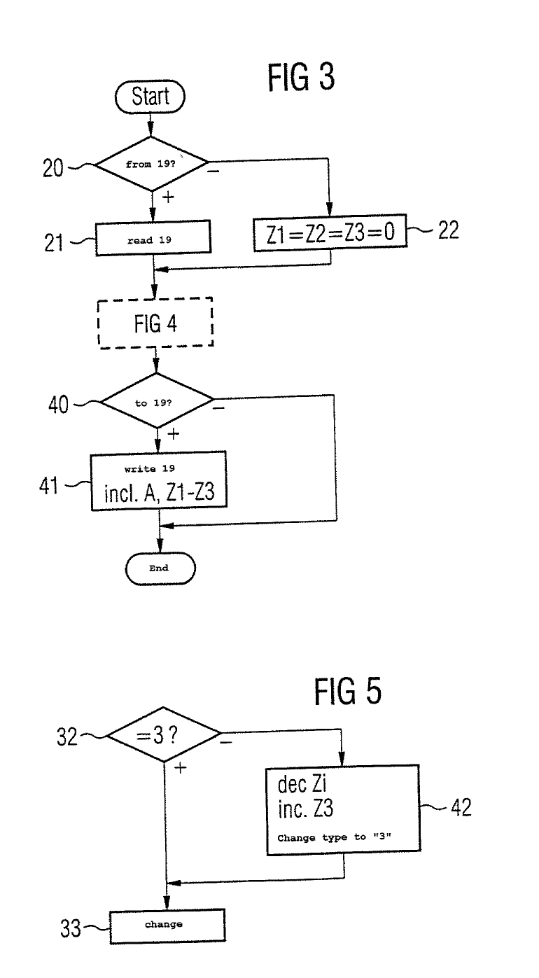

The technical installation according to FIG. 1 will now be planned via a computer 7, programmed with a project planning tool 8 which can be stored in a memory (not shown), according to FIG. 2 of an embodiment of the present invention. For this purpose, customary input and output units 9 to 12, for example a keypad 9, a mouse 10 (and/or other input units), a monitor 11 and a printer 12 (and/or other output units), are assigned to the computer 7. The computer 7 communicates with a schematically illustrated user 13 via the units 9 to 12 to permit selection, permit specification, etc. The computer 7 includes a processor (not shown) for performing necessary processing steps of the method discussed in FIGS. 3-5 in conjunction with information selected/input/specified via input devices 9, 10, based upon the tool 8 stored in memory. In addition, the computer 7 can, if appropriate, be assigned an interface 14 via which the computer 7 is connected to a computer network 15, for example the Internet 15. Within the scope of the processing of the project planning tool 8, which is a program module (which can be embodied in any computer readable medium such as a CD, ROM, etc.), the computer 7 accesses here, inter alia, files, or file systems shown as elements 16 to 19, for example. The files 16 to 19 are preferably, but not necessarily, embodied as ASCII files, and are not limited to the number of files shown in FIG. 2.

The files 16 and 17 are exemplary catalog files. Such files be read only from the programming tool 8. According to FIG. 2, the files 16 to 19 are assigned directly to the computer 7 here. However, it would also be possible to call the files 16 to 19 from another computer via the computer network 15, etc.

The file 16 can contain technical descriptions of elements, including manufacturer's information, type designation and a uniquely defined order number, for example. Elements whose description is included in the file 16, fulfill the specifications stipulated there. If, therefore, the technical installation is planned exclusively with elements whose descriptions are stored in the file 16, it is possible to guarantee that the technical installation in practice actually fulfils the requirements made of it on the basis of the planning. The elements of the file 16 are therefore assigned a description priority number which is, for example, uniformly 1.

The file 17 may also contain descriptions of elements which are commercially available on a standard basis. The elements whose descriptions are stored in the file 17 have, however, may not have been tested by the producer of the programming tool 8. If elements whose description is stored in the file 17 are also used for planning the technical installation, the producer of the programming tool 8 can thus only vouch for these elements being available. Whether they actually have the properties stipulated in their description is unknown to the producer of the file 17. These elements are therefore assigned the description priority number 2, for example, without exception.

The exemplary catalog files 16 and 17 can only be called and read from the programming tool 8 by the user 13. It is not possible to change or overwrite such files 16, 17.

The file 18 may also contain descriptions of elements. In contrast to the files 16 and 17, the file 18 can, for example, both be read and written to. The file 18 can contain individual descriptions of technical elements which have been produced by the user 13 himself. The producer of the project planning tool 8 is therefore unaware as to whether the described elements are actually available or whether they have the stipulated properties. The descriptions of the file 18 are therefore assigned the description priority number 3, for example, without exception.

The programming tool 8 may include a plurality of code segments which cause the to plan a technical installation by performing a series of steps based upon interactively specified descriptions of technical elements. The steps will be described in connection with the interactively specified descriptions, with regard to FIGS. 3-5, wherein it is understood that the tool 8 interacts with the computer 7, and can be stored on a computer readable medium.

Within the scope of the processing of the project planning tool 8 as shown in FIG. 3, there is firstly an interrogation, in a step 20, to determine whether data are to be read out of the file 19. The file 19 is an installation file which contains descriptions of elements and topology of a previously planned technical installation, for example. The file 19 also contains meters Z1, Z2 and Z3 and an installation priority number A. The counters Z1, Z2 and Z3 stipulate how many elements 1 to 5 with the description priority number 1, 2 or 3 are present in the planned installation. Depending on the input values, either the file 19 is read by the user in a step 21 or the counters Z1, Z2 and Z3 are set to the value 0 in a step 22.

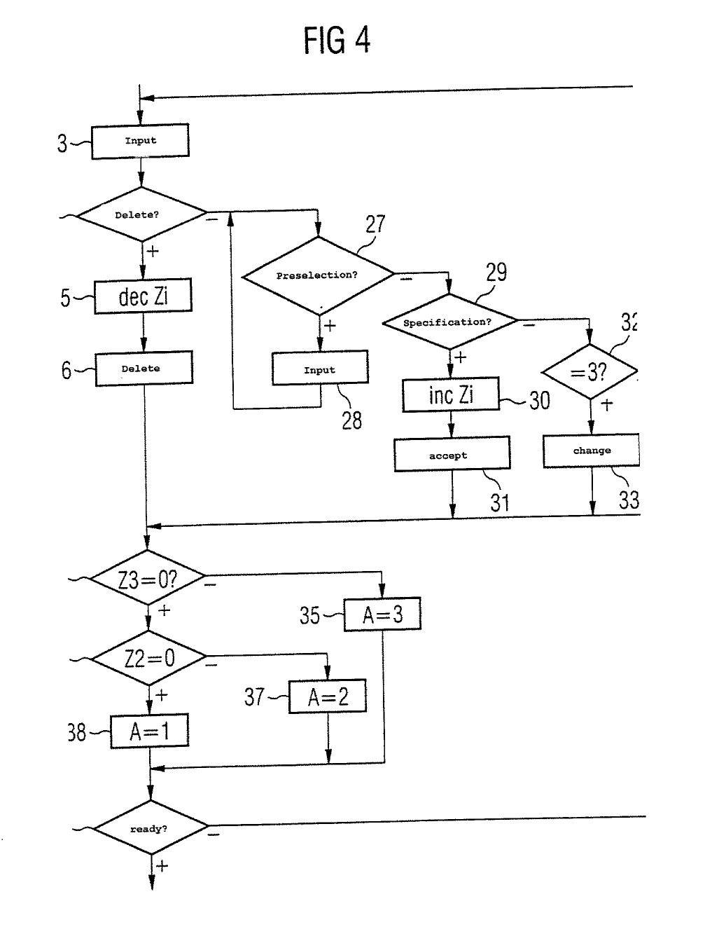

Thereafter, according to FIG. 4, the user 13 then interactively interrogates an input in a step 23.

In a step 24 it is initially checked whether the input was a delete instruction. If it was, in a step 25 the description priority number of the element to be deleted is determined and the corresponding counter Zi (i=1, 2 or 3) is reduced by one. The input delete instruction is then executed in a step 26.

Otherwise, if the output was not a delete instruction, in a step 27 it is checked whether the input was a pre-selection, i.e. whether the user has, for example (only) input that he is selecting a motor, a contactor or a cable. If this is the case, in a step 28, the user 13 is offered a corresponding subset, the next input is waited for, and the system then returns to the step 27.

Otherwise, if the input was not a preselection, in a step 29 it is checked whether a predefined standard description or possibly an individual description, which has been previously produced by the user, has been specified. If it has, in a step 30, the corresponding counter Zi is increased by one and the input specification is executed in a step 31.

If there is neither a delete instruction nor a specification, an already specified element must have been changed. In this case, it is therefore checked in a step 32 to determine whether the description of the element which is to be changed has been assigned the description priority number 3. Only in this case is the requested change executed in a step 33, and otherwise the execution is denied.

After the routine described above has been processed, in a step 34, it is interrogated whether the counter Z3 has the value 0. If not, the technical installation is assigned the installation priority number A=3 in step 35. If so, in a step 36 it is checked whether the counter Z2 has the value 0. If not, the technical installation is assigned the installation priority number A=2 in a step 37.

The technical installation is thus assigned an installation priority number A=1 in a step 38 only if it is composed exclusively of elements which have been obtained from the file 16 (if step 36 is yes). If, on the other hand, only one of the elements has been obtained from the file 17, the installation already receives the installation priority number A=2 in step 37. If even one of the elements has been obtained from the file 18 or has been produced individually by the user in some other way, the technical installation receives the installation priority number A=3 in step 35.

Finally, in a step 39 it is interactively interrogated whether the planning of the technical installation has been concluded. If not, in a step 23 the next input is interrogated and otherwise, in a step 40 in FIG. 3, it is interrogated whether the planned technical installation is to be input to the file 19. If it is, in a step 41 the descriptions of the specified elements 1 to 5 and their topology together with the installation priority number A and the counters Z1 to Z3 are stored in the file 19. The processing of the project planning tool 8 is then concluded.

FIG. 5 shows one alternative, when specifying a change. According to FIG. 5, in the case in which a description which is assigned the description priority number 1 or 2 is to be changed, this change can be executed in step 33. However, in a step 42 the counter (Zi=1, 2) for the number of elements with the description priority number 1 or 2 is previously decremented by 1, and a counter Z3 for the number of elements with the description priority number 3 is incremented. In addition, in step 42 the description priority number assigned to this description is changed to 3.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of using a computer-supported project planning tool via which a technical installation can be planned by interactively specifying a number of descriptions of technical elements and by describing topology, comprising:
receiving a selection, by a user of the project planning tool, of at least one catalog including a number of standard descriptions of elements whose standard descriptions cannot be changed by the user and to which a first description priority number is assigned;
receiving a specified at least one further description of the project planning tool; and
assigning an installation priority number to planned technical installation by the project planning tool, wherein the first description priority number is assigned to the planned technical installation by the project planning tool as an installation priority number only if standard descriptions to which the first description priority number is assigned are selected for the project planning of the technical installation, and wherein an installation priority number which is different from the first description priority number, is otherwise assigned to the planned technical installation by the project planning tool.

2. The method as claimed in claim 1, wherein the further descriptions comprise at least one individual description, produced from the project planning tool by the user, and at least one predefined standard description which cannot be changed from the project planning tool by the user, and which is assigned a second description priority number which is different from the first description priority number, wherein the second description priority number is assigned to the planned technical installation by the project planning tool as an installation priority number only if standard descriptions are selected for planning the technical installation and at least one of the selected standard descriptions is assigned the second description priority number, and wherein the installation priority number otherwise has a value which is different from the description priority numbers.

3. The method as claimed in claim 1, wherein the predefined standard descriptions are readable by the project planning tool from at least one standard file.

4. The method as claimed in claim 3, wherein the standard file is embodied as an ASCII file.

5. The method as claimed in claim 1, wherein the specified elements and their topology can be stored in an installation file.

6. The method as claimed in claim 5, wherein the installation file is embodied as an ASCII file.

7. The method as claimed in claim 1, wherein, for the selection of a standard description, the user can be offered a subset of the number of predefined standard descriptions.

8. The method as claimed in claim 1, wherein the standard descriptions can be called to a computer network from the project planning tool.

9. The method as claimed in claim 1, wherein the elements are electrical elements.

10. The method as claimed in claim 9, wherein the elements include low-voltage switching devices and elements connected upstream and downstream the low voltage switching devices.

11. A computer-supported project planning tool for causing a computer to plan a technical installation using a number of interactively specified descriptions of technical elements, comprising:
a first code segment for causing a computer to receive a selection, by a user of the project planning tool, of at least one catalog including a number of standard descriptions of elements whose standard descriptions cannot be changed by the user and to which a first description priority number is assigned;
a second code segment for causing a computer to receive a specified at least one further description of the project planning tool; and
a third code segment for causing a computer to assign an installation priority number to planned technical installation by the project planning tool, wherein the first description priority number is assigned to the planned technical installation by the project planning tool as an installation priority number only if standard descriptions to which the first description priority number is assigned are selected for the project planning of the technical installation, and wherein an installation priority number which is different from the first description priority number, is otherwise assigned to the planned technical installation by the project planning tool.

12. The computer-supported project planning tool of claim 11, wherein the further descriptions comprise at least one individual description, produced from the project planning tool by the user, and at least one predefined standard description which cannot be changed from the project planning tool by the user, and which is assigned a second description priority number which is different from the first description priority number, wherein the second description priority number is assigned to the planned technical installation by the project planning tool as an installation priority number only if standard descriptions are selected for planning the technical installation and at least one of the selected standard descriptions is assigned the second description priority number, and wherein the installation priority number otherwise has a value which is different from the description priority numbers.

13. The computer-supported project planning tool of claim 11, wherein the predefined standard descriptions are readable by the project planning tool from at least one standard file.

14. The computer-supported project planning tool of claim 13, wherein the standard file is embodied as an ASCII file.

15. The computer-supported project planning tool of claim 11, wherein the specified elements and their topology can be stored in an installation file.

16. The computer-supported project planning tool of claim 15, wherein the installation file is embodied as an ASCII file.

17. The computer-supported project planning tool of claim 11, wherein, for the selection of a standard description, the user can be offered a subset of the number of predefined standard descriptions.

18. The computer-supported project planning tool of claim 11, wherein the standard descriptions can be called to a computer network from the project planning tool.

19. The computer-supported project planning tool of claim 11, wherein the elements are electrical elements.

20. The computer-supported project planning tool of claim 19, wherein the elements include low-voltage switching devices and elements which are connected upstream and downstream the low voltage switching devices.

21. The computer-supported project planning tool of claim 11, wherein the tool is embodied in a computer readable medium.

22. An apparatus, comprising:
a memory for storing a project planning tool;
selection means for permitting a user of the project planning tool to select at least one catalog including a number of standard descriptions of elements, whose standard descriptions cannot be changed by the user and to which a first description priority number is assigned, wherein the selection means further permits specification of at least one further description of the project planning tool; and
computer means for assigning an installation priority to a technical installation by the project planning tool, wherein the first description priority number is assigned to the planned technical installation by the project planning tool as an installation priority number only if standard descriptions to which the first description priority number is assigned are selected for the project planning of the technical installation, and wherein an installation priority number which is different from the first description priority number, is otherwise assigned to the planned technical installation by the project planning tool.

23. The apparatus as claimed in claim 22, wherein the further descriptions comprise at least one individual description, produced from the project planning tool by the user, and at least one predefined standard description which cannot be changed from the project planning tool by the user, and which is assigned a second description priority number which is different from the first description priority number, wherein the second description priority number is assigned to the planned technical installation by the project planning tool as an installation priority number only if standard descriptions are selected for planning the technical installation and at least one of the selected standard descriptions is assigned the second description priority number, and wherein the installation priority number otherwise has a value which is different from the description priority numbers.

24. The apparatus as claimed in claim 22, wherein the predefined standard descriptions are readable by the project planning tool from at least one standard file.

25. The apparatus as claimed in claim 24, wherein the standard file is embodied as an ASCII file.

26. The apparatus as claimed in claim 22, wherein the specified elements and their topology can be stored in an installation file.

27. The apparatus as claimed in claim 26, wherein the installation file is embodied as an ASCII file.

28. The apparatus as claimed in claim 22, wherein, for the selection of a standard description, the user can be offered a subset of the number of predefined standard descriptions.

29. The apparatus as claimed in claim 22, wherein the standard descriptions can be called to a computer network from the project planning tool.

30. The apparatus as claimed in claim 23, wherein the elements are electrical elements.

31. The apparatus as claimed in claim 30, wherein the elements include low-voltage switching devices and elements which are connected upstream and downstream the low voltage switching devices.
